(19) United States
(12) Patent Application Publication
(10) Pub. No.: US 2012/0330686 A1
(43) Pub. Date: Dec. 27, 2012

(54) SYSTEM AND METHOD FOR AUTOMATED SUITABILITY ANALYSIS AND DOCUMENT MANAGEMENT

(75) Inventors: Richard J. Wirth, West Hartford, CT (US); Adam A. Cohan, Berlin, CT (US); Lisa Levin, Avon, CT (US); Richard W. Vynalek, Durham, CT (US)

(73) Assignee: HARTFORD FIRE INSURANCE COMPANY, Hartford, CT (US)

(21) Appl. No.: 13/165,252

(22) Filed: Jun. 21, 2011

(51) Int. Cl. G06Q 40/00

(52) U.S. Cl. 705/4

(57) ABSTRACT

A suitability management system for evaluating insurance product recommendations for customers suitability is provided. The suitability management system may generate a dynamic suitability questionnaire document based on a stored template in view of a number of business rules and the generated suitability document may be provided to the insurance consumer for completion and subsequent scoring. The scored document is evaluated using a comprehensive scoring process to evaluate the consumer's acumen, risk tolerance and solvency. The system is configured to interface with a third party to conduct the suitability analysis.

### BACKGROUND

Brokers of “securities” such as variable universal life insurance products and variable annuities are subject to a series of regulations and guidelines during the sale of such products. For example, a retail seller of such products must conduct themselves in a fair and equitable manner with their customers, have a reasonable basis for recommending a particular security or strategy to a particular customer, and have reasonable grounds for believing that the customer understands the investment or strategy, and the risks involved in selecting such an investment. Generally, this process for validating the recommendations to buy such products is called “suitability.” The suitability analysis essentially verifies the sales approach for the product being offered based on a review of the individual's respective financial situation, risk tolerance, experience, liquidity and a number of other factors.

By way of example, recommending a speculative, high risk security to a customer without any attempt to obtain information regarding the customer's other securities holdings, his or her financial background and situation, and similar information would run afoul of current rules and regulations and may subject the broker to certain fines, sanctions and other penalties. Many of these rules governing the selling of financial products are mandated by the Financial Industry Regulatory Authority's (FINRA) Conduct Rules. Additional rules and regulations such as promulgated by the Securities and Exchange Commission (SEC) may also apply during the sale of certain financial and/or insurance products to consumers.

While these suitability guidelines currently apply to investments classified as securities, certain state regulatory bodies have begun to prescribe certain suitability standards and procedures for “non security” type products such as income annuities, deferred annuities, fixed indexed annuities and the like (collectively, “insurance products”). In fact, the National Association of Insurance Commissioners (NAIC) and certain state governing regulators such as state based Departments of Insurance (DOI) have been promulgating standards or so-called model-regulations for the standardization of suitability inquiries for the sale of such annuity products.

Generally, when qualifying recommendations of these types of insurance products to consumers, a designated broker or agent uses a paper based suitability form or questionnaire to gather certain essential facts relating to his customers, their financial situations and goals, and their investment experience. The form or questionnaire helps the broker or agent to learn all essential facts regarding the particular product being recommended and to have a reasonable basis for recommending that insurance product to that particular customer.

However, as with suitability determinations for conventional securities, qualifying investors for annuity type products is also a very time consuming, cumbersome and manual process. Accordingly, it would be desirable to have an expedited and efficient way to accurately and conveniently determine the suitability of investors and improve the user experience of both agents and customers seeking to purchase such insurance products.

### SUMMARY

In one embodiment, the present invention is a system for managing and scoring suitability data for selection of one or more insurance products for one or more consumers, comprising a data storage device storing data associated with an insurance product suitability database; a computer processor for executing program instructions and for retrieving said data associated with the insurance product suitability database from the data storage device; and a memory, coupled to the computer processor, storing program instructions for execution by the computer processor to receive, from a remote consumer entity, a request for information on one or more of the insurance products stored on the insurance product suitability database, the request also including information specific to the remote consumer entity; render a dynamic suitability questionnaire based on the received request, the dynamic suitability questionnaire customized based on the information specific to the remote consumer entity, receive, from the remote consumer entity, data provided in response to the rendered suitability questionnaire; store the received data in the insurance product suitability database; analyze the stored data based on a set of suitability rules to determine a suitability score based on at least the consumer entity's acumen, tolerance and solvency; and transmit, based on the analysis, data related to certain selected insurance products for presentation to the consumer.

In one embodiment, the present invention is a computer-implemented method for generating a scoring a suitability questionnaire for evaluating suitability for a non-security product, the method comprising receiving, via a communication interface, a message from a computing device that indicates a request for a suitability questionnaire; dynamically compiling, via at least one processor, a suitability questionnaire for transmission to a user via the communications interface, wherein the suitability questionnaire comprises a plurality of questions for completion by the user, each question having an associated suitability score assigned to each question; receiving, via the communications interface, information responsive to the suitability questionnaire; storing, in at least one storage device, the information responsive to the suitability questionnaire; scoring, by the at least one processor, the information responsive to the suitability questionnaire based at least in part on the suitability score assigned to each question in the suitability questionnaire; and transmitting, via the communication interface, information related to the purchase of the fixed annuity product, to the computing device.

In one embodiment, the present invention is a system for generating and scoring suitability data for one or more insurance products, the system comprising a communication interface configured to receive data from a computing device that indicates a request for a suitability document, wherein the request for the suitability questionnaire document relates to a request by an insurance consumer for the one or more insurance products; and at least one processor configured to: selectively compile suitability questions, each question associated with a suitability score, aggregated scores forming certain scoring ranges; receive consumer answers to each of the suitability questions via the communications interface, the answers being aggregated to form an overall suitability score; and correlating the overall suitability score to one or more of the scoring ranges to form a suitability evaluation; wherein the communication interface is further configured to transmit data related to one or more of the insurance products based on the correlation of the overall suitability score and the one or more scoring ranges to the computing device.

### BRIEF DESCRIPTION OF THE DRAWINGS

A more detailed understanding may be had from the following description, given by way of example in conjunction with the accompanying drawings wherein:

FIG. 1a shows an exemplary agent based architecture that may be used for the management, scoring and communication of suitability related documents;

FIG. 1b shows another exemplary web architecture that may be used for the management, scoring and communication of suitability related documents;

FIG. 2 shows an exemplary system that may be used for the management, scoring and communication of suitability documents;

FIG. 3 shows an exemplary of a number of system screens of the present invention;

FIG. 4 shows an exemplary system device in operation;

FIG. 5 shows an exemplary method of the present invention;

FIG. 6 shows another exemplary method of the present invention;

FIG. 7 shows another exemplary device of the present invention;

FIG. 8 shows an exemplary suitability scoring document that may be generated using the features described herein;

FIG. 9 shows another exemplary suitability scoring document that may be generated using the features described herein;

FIG. 10 shows an exemplary suitability scoring document that may be generated using the features described herein;

FIG. 11 show another exemplary suitability scoring results document that may be generated using the features described herein; and

FIG. 12 show another exemplary suitability scoring results document that may be generated using the features described herein.

### DETAILED DESCRIPTION

Disclosed herein are processor-executable methods, computing systems, and related technologies for the management and communication of suitability data and related information. Generally, insurance and/or financial services companies, their agents and other entities involved in the sale of insurance products may use the present invention to accurately and efficiently validate recommendations of certain insurance products for sale to potential customers. For example, utilizing the present invention, an agent acting behalf of an insurance company may use the system to validate a purchase recommendation made to a customer through use of a dynamic questionnaire form and scoring system. The dynamic questionnaire form may be submitted for approval by an insurance company concurrently with an application for the product that was recommended to the customer. The system may be configured to pre-fill responses to one or more questions in the suitability questionnaire based on data received in the product application. Additionally, an agent acting behalf of an insurance company may use the system to pre-screen customers to help determine which insurance products, such as fixed annuities, fixed deferred annuities, and single premium immediate annuities, are suitable for recommendation to each specific customer. In another alternative embodiment, a customer may also access and use the system directly to help determine which insurance products, such as fixed annuities, are suitable for them. As used herein the terms “client”, “consumer”, “individual”, “user” and “customer” may be used interchangeably to refer to a third party entity interacting with or operating the system of the present invention and the terms “agent”, “client”, “user” and “employee” may also be used interchangeably to refer to an insurance company related or affiliated entity interacting with or operating the system of the present invention.

In the present invention, a central suitability data management system may manage and store suitability questionnaire documents that may be used by agents and/or consumers to complete certain suitability questionnaire documents and then determine the suitability of recommending certain insurance products based on scoring of the suitability documents. The products may be non-security products, including fixed annuities such as fixed deferred annuities and single premium immediate annuities. The suitability data management system may receive a request for a suitability document for obtaining certain suitability information from a consumer, and generate a customized suitability document based on a rules engine and one or more templates managed by the suitability data management system. The contents of the suitability document may be customized according to the consumer's requests, the state and/or federal laws and regulations that apply, attributes of the consumer, and/or other factors. Additionally, a consumer may request to purchase a new insurance and/or financial services product via the web interface after the suitability document is completed and scored.

The present invention also includes a web interface that may be used to present suitability questions in an electronic questionnaire to obtain the consumer's personal information. The content and formatting of the questions presented to the consumer may also be based on the templates managed by the central suitability data management system. Because suitability documents and the questions presented by the web interface are generated dynamically in response to specific requests based on the templates, insurance consumers may receive suitability documents and suitability questions that are customized for their particular circumstances. Further, when an update to a suitability template is required, a user, such as an insurance company home office compliance specialist, may update the template in the central suitability management system, thereby ensuring that consumers receive the most up-to-date suitability documents and suitability questions, and also ensuring consistency across the suitability documents and web interface. The system is able to automatically score the completed suitability documents and correlate the score to one or more products which may be suitably recommended for the consumer.

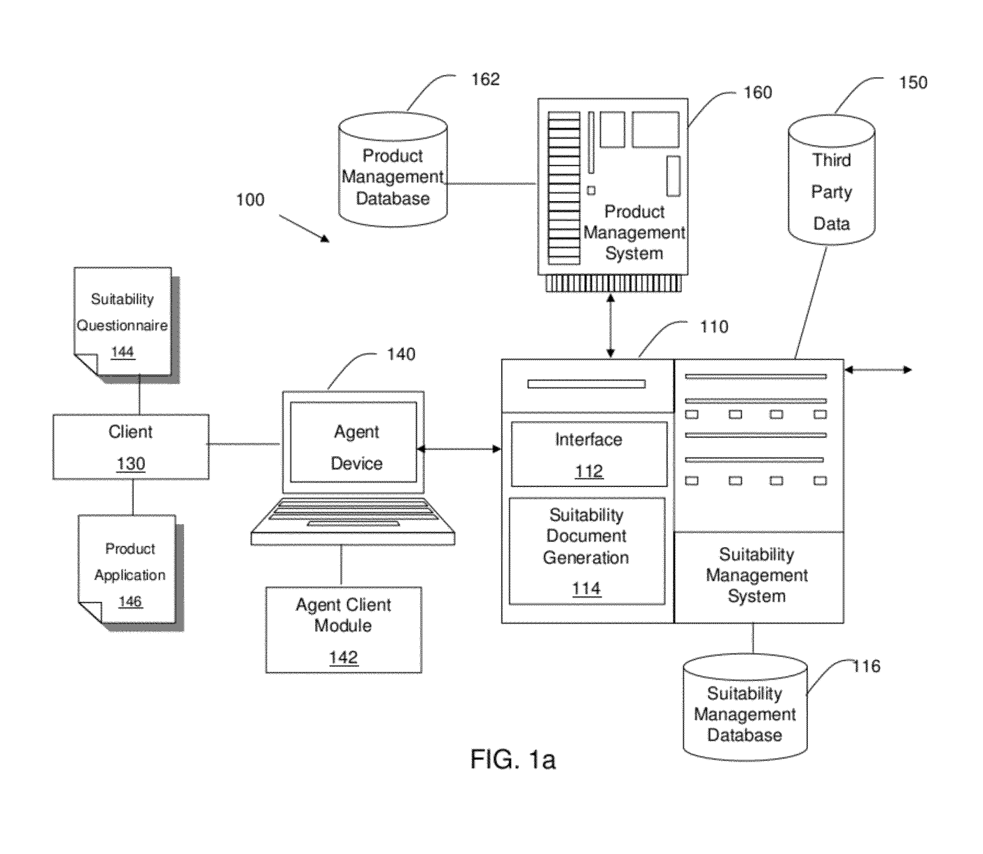

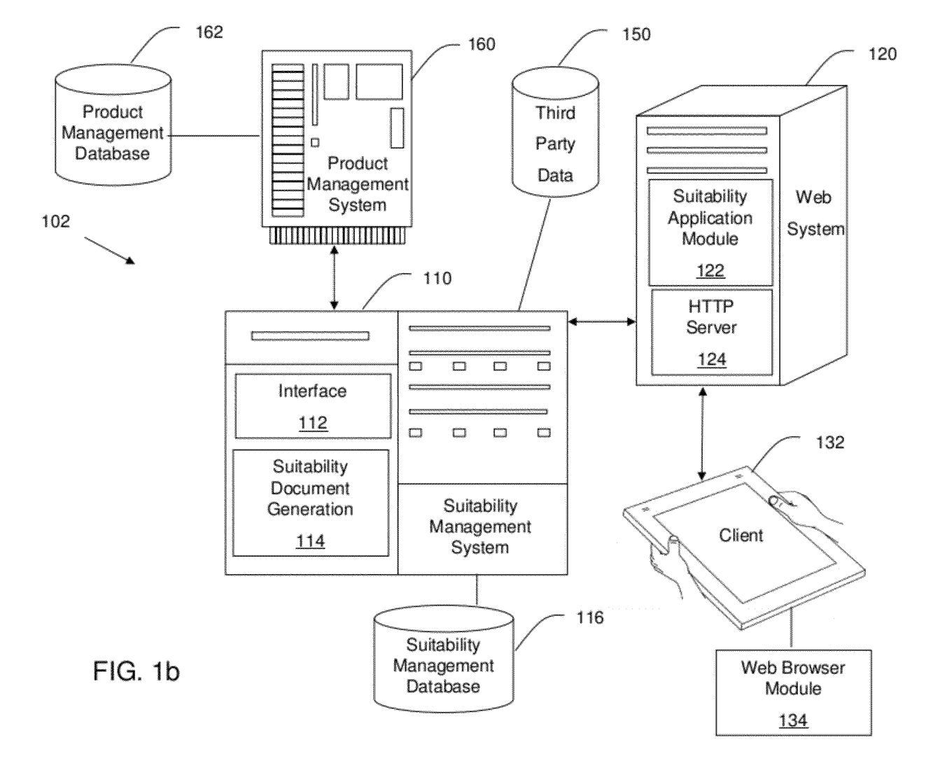

FIG. 1 shows an example architecture 100 that may be used for the management, scoring and communication of suitability related documents. The example architecture 100 may include a suitability data management system 110, a consumer/client entity 130, an agent device 140 and an insurance product management system 160. In the example architecture 100 of FIG. 1, the suitability management system 110 and the product management system 160 may be under the control of an insurance/financial services company and their associated agents. In other embodiments, suitability management system 110 may be integrated with product management system 160.

As will be described in further detail below, the suitability management system 110 may generate a customized suitability questionnaire document 144 that may be provided to consumers for completion in conjunction with a product application 146 to verify that the product being recommended by the agent is suitable for client 130. According to this approach, an employee, agent or affiliated entity of the insurance company that operates agent device 140 may receive a request from client 130 to purchase an insurance product such as a fixed annuity. The employee, agent or affiliated entity of the insurance company may request an appropriate suitability document from the suitability management system 110, and then provide the suitability document to the client 130 for completion.

The suitability management system 110 may include an interface module 112, a suitability document generation module 114, and a suitability management database 116. The suitability document generation module 114 may receive input data and, using one or more suitability templates and corresponding rules, may generate customized suitability document 144 based on the input data.

The suitability management database 116 may store information such as the information that describes the suitability templates used by the suitability document generation module 114 as well as information related to completed suitability documents that have been accessed by consumers. The suitability management database 116 may be spread across one or more computer-readable media, and may be or include one or more relational databases, hierarchical databases, object-oriented databases, one or more flat files, one or more spreadsheets, and/or one or more structured files. The suitability management database 116 may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology. Communication between the suitability management system 110 and the other elements 140 and 160 in the example architecture 100 of FIG. 1 may be performed via the interface module 112 in the suitability management system 110. Suitability management system 110 may also access third party data 150 which may include credit history, social network history and activity and other sources of information which may impact the suitability determination herein.

Referring still to FIG. 1a, the product management system 160 may perform functionality such as storing and processing information that describes insurance and/or financial services products and characteristics of such products. For example, product management system 160 may include information on certain types of annuity products, such as fixed and income annuities and their respective product features such as premiums, rates, income access, payout periods, income start dates, flexibility of payment types and fees. The product management system 160 may store this information in a product management database 162. The policy management database 162 may be spread across one or more computer-readable media, and may be or include one or more relational databases, hierarchical databases, object-oriented databases, one or more flat files, one or more spreadsheets, and/or one or more structured files. As will be described in further detail below, the suitability management system 110 may use information from the product management database 162 to generate potential products which may be suitable for one or more consumers or investors based on information from one or more suitability documents.

The agent device 140 may be a computer or other type of data processing device or computing device, and may be operated by an employee of the insurance company to perform marketing, scoring and certain administrative functions for the suitability management system 110. The agent device 140 may include an agent client module 142, which may be or include a web browser application, a specific-purpose client application, and/or any other appropriate type of application. The agent device 140 may receive input from input devices (not depicted) that are included in or connected to the agent device 140. These input devices may include, for example, a keyboard, a mouse, or a touch screen, and provide data that indicates the input to the agent client module 142. The agent client module 142 in the agent device 140 may communicate with the interface module 112 in the suitability management system 110. As one example, an operator of the agent device 140, such as an insurance agent or an employee of the insurance company, may provide input data to the agent client module 142 that indicates that one of the suitability documents in the suitability management database 116 should be scored or that such a suitability document needs to updated based on a new internal or external regulation, law or guideline affecting that suitability document.. The agent client module 142 may communicate this data to the interface module 112 in the suitability management system 110, which may then update the suitability management database 116 accordingly.

Further, the agent client module 142 may communicate with the suitability document generation module 114 in the suitability management system 110. As one example, an operator of the agent client module 142 may receive an inquiry from an insurance consumer/client for information related to an insurance product such as a fixed annuity type product. The operator of the agent client module 142 may compile information related to the request, such as an identifier of the insurance consumer, information describing the requested product, and/or other information. This information may be part of a product purchase application which is concurrently completed for submission to the insurance entity. The agent client module 142 may then communicate this information to the suitability document generation module 114 via the interface module 112 in the in the suitability management system 110. The suitability document generation module 114 may generate suitability questionnaire document 144 that corresponds to the request. It is contemplated that some of the preliminary information provided for the product application may be used to pre-fill the suitability document, such as information related to the consumer's name, address, etc which is provided on product application 146. As discussed in more detail later herein, suitability questionnaire document 144 is completed for scoring and submitted concurrently with the product application to validate the recommended product for purchase. In alternative embodiments, suitability questionnaire document 144 may be submitted in advance of any product application to help determine one or more product(s) that may be suitably recommended for the consumer/client.

Referring now to FIG. 1b, a web site system 120 may provide a web site that may be accessed by an insurance consumer operating the consumer client device 132. The web site system 120 may generate one or more web pages that contain certain product information, and certain suitability information, may communicate the suitability documents, such as via a dedicated web page, to the consumer client device 132, and may receive responsive information from the consumer client device 132. The responsive information may include information that identifies the insurance consumer, information that describes the product that the consumer is requesting, suitability type information, and/or other information. The web site system 120 may then communicate this information to the suitability management for scoring and evaluation, pre-filling product application forms, etc. The web site system 120 may then communicate one or more web pages to the consumer client device 132 that provide one or more product options that may be suitable for the consumer, such as one or more fixed and/or income type annuity options from product management system 160.

The web site system 120 may include a HyperText Transfer Protocol (HTTP) application server module 124 and a suitability web application module 122. The HTTP server module 124 may implement the HTTP protocol, and may communicate HyperText Markup Language (HTML) pages and related data from the web site to/from the consumer client device 132 using HTTP. The HTTP server module 124 may be, for example, a Sun-ONE Web Server, an Apache HTTP server, a Microsoft Internet Information Services (IIS) server, and/or may be based on any other appropriate HTTP server technology. The web site system 120 may also include one or more additional components or modules (not depicted), such as one or more switches, load balancers, firewall devices, routers, and devices that handle power backup and data redundancy. The suitability web application module 122 may generate the web pages that make up the web site and that are communicated by the HTTP server module 124. The suitability web application module 122 may be implemented in and/or based on a technology such as Active Server Pages (ASP), PHP: Hypertext Preprocessor (PHP), Python/Zope, Ruby, any server-side scripting language, and/or any other appropriate technology.

Referring still to FIG. 1b, the consumer client device 132 may include a web browser module 134, which may communicate data related to the web site to/from the HTTP server module 124 and the suitability web application module 122 in the web site system 120. The web browser module 134 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 134 may implement Rich Internet Application (RIA) and/or multimedia technologies such as Adobe Flash, Microsoft Silverlight, and/or other technologies. The web browser module 134 may implement RIA and/or multimedia technologies using one or web browser plug-in modules (such as, for example, an Adobe Flash or Microsoft Silverlight plugin), and/or using one or more sub-modules within the web browser module 134 itself. The web browser module 134 may display data on one or more displays that are included in or connected to the consumer client device 132, such as a liquid crystal display (LCD) display, touch screen or monitor. The consumer client device 132 may receive input from the user of the consumer client device 132 from input devices (not depicted) that are included in or connected to the consumer client device 132, such as a keyboard, a mouse, or a touch screen, and provide data that indicates the input to the web browser module 134. The consumer client device 132 may be, for example, a cellular phone, a laptop computer, a tablet computer, or any other appropriate computing device.

The example architectures 100 and 102 of FIGS. 1a and 1b may also include one or more wired and/or wireless networks (not depicted), via which communications between the elements 110, 120, 132, 140 and 160 in the example architecture 100 may take place. The networks may be private or public networks, and/or may include the Internet. In one example deployment scenario, the suitability management system 110, web site system 120, suitability management system 110, and product management system 160 may communicate via one or more private networks that are under the control of the insurance company, while the consumer client device 132 may communicate with the web site system 120 via the Internet.

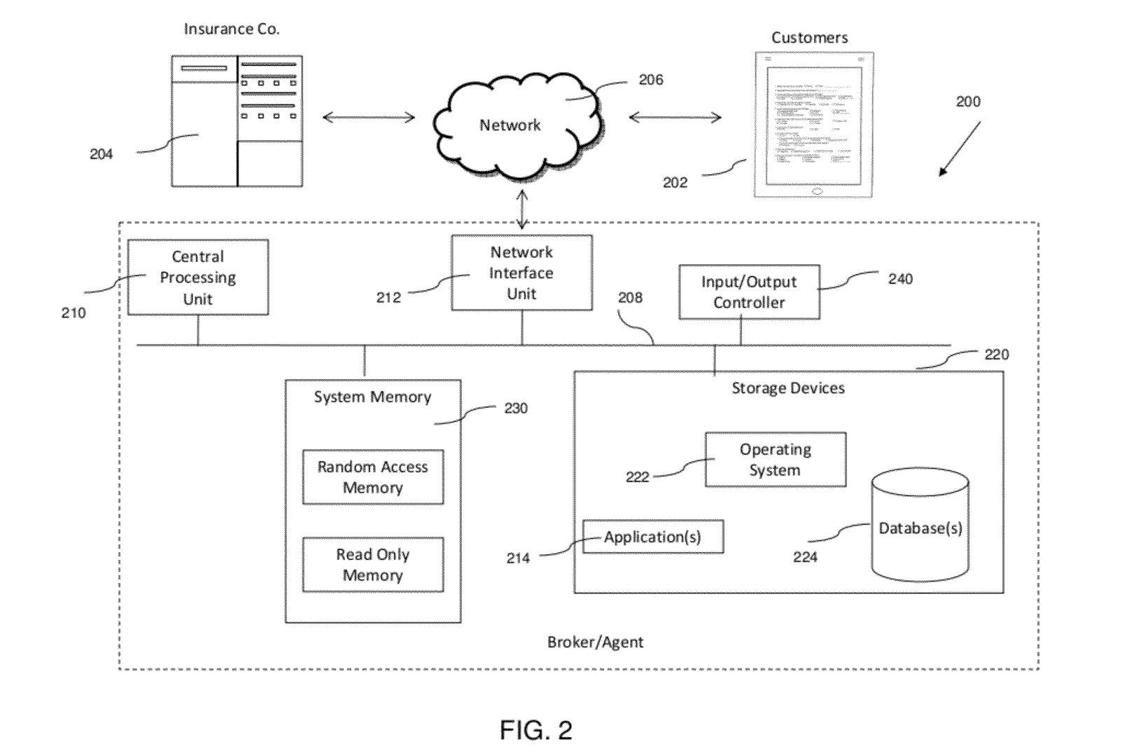

Each or any combination of the modules 112, 114, 122, 124, 134 and 142 shown in FIGS. 1a and 1b may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules 112, 114, 122, 124, 134 and 142 may perform functionality described herein with reference to FIGS. 2-12.

Referring to FIG. 2, another exemplary computer system 200 for use in an implementation of the invention will now be described. Computer system 200 may be an agent system configured to perform suitability analysis and management of suitability information and documents for one or more customers 202. System 200 may interface with an insurance company system or server 204 via a network 206. In computer system 200, a processor 210 executes instructions contained in programs such as suitability management application program 214, stored in storage devices 220. Processor 210 may provide the central processing unit (CPU) functions of a computing device on one or more integrated circuits. The term “processor” may include multi-core processors and central processing units including multiple microprocessors. Storage devices 220 may include suitable media, such as optical or magnetic disks, fixed disks with magnetic storage (hard drives), tapes accessed by tape drives, and other storage media. Processor 210 communicates, such as through bus 208 and/or other data channels, with network interface unit 212, system memory 230, storage devices 220 and input/output controller 240. Via input/output controller 240, processor 210 may receive data from user inputs such as pointing devices, touch screens, audio inputs and keyboards, and may provide data to outputs, such as data to video drivers for formatting on displays, and data to audio devices.

Storage devices 220 are configured to exchange data with processor 210, and may store programs containing processor-executable instructions, and values of variables for use by such programs. Processor 210 is configured to access data from storage devices 220, which may include connecting to storage devices 220 and obtain data or read data from the storage devices, or place data into the storage devices. Storage devices 220 may include local and network accessible mass storage devices. Storage devices 220 may include media for storing operating system 222 and mass storage devices such as storage 224 for storing data related to suitability scoring employed in evaluating the suitability questionnaires. Such data may include product information, scores corresponding to certain suitability questions and other relevant data. In an embodiment, inputs may include user interfaces, including workstations having keyboards, touch screens, pointing devices such as mice, or other user input devices, connected via networked communications to processor 210. Network interface unit 212 may communicate via network 206 with other insurance company computer systems such as insurance company system servers 204 as well as other servers, computer systems of agents, financial advisors, customers, remote sources of data, and with systems for implementing instructions output by processor 210. Insurance company server 204 may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. Network 206 may be or include wired or wireless local area networks and wide area networks, and over communications between networks, including over the Internet. Any suitable data and communication protocols may be employed.

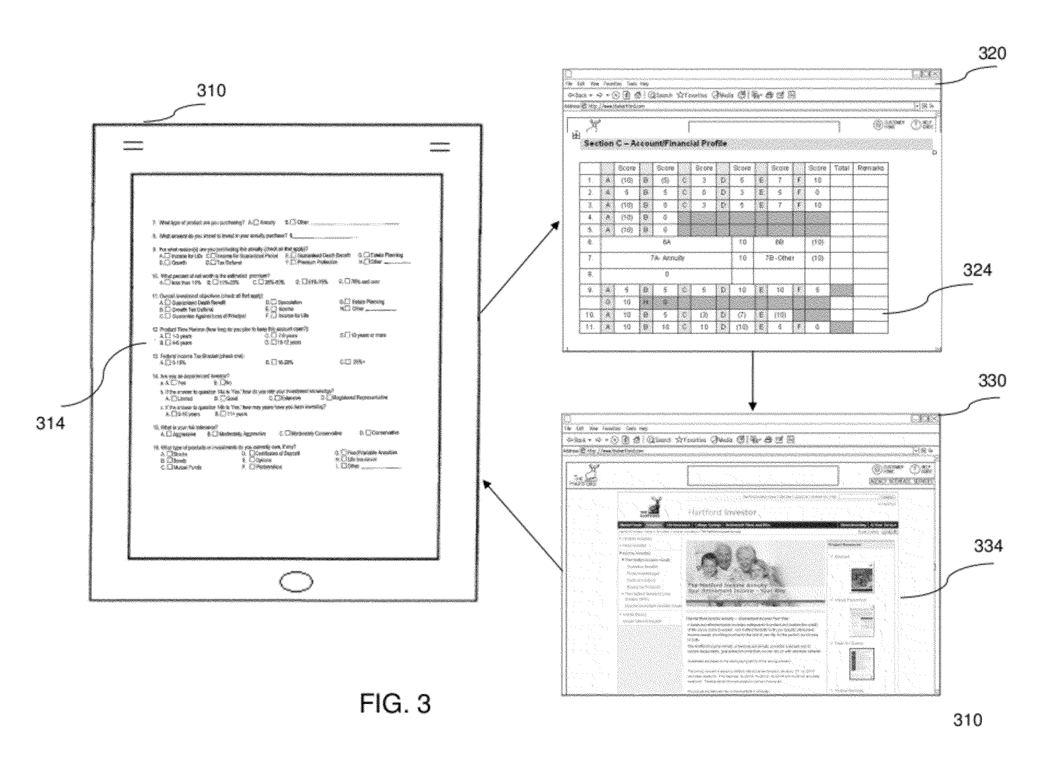

FIG. 3 illustrates an exemplary series of screens of the present invention as may be displayed among devices shown in FIGS. 1a and 1b. In one embodiment, a consumer shopping for one or more insurance/financial service products operates a device 310, such as a touch screen type device. Touch screen device 310 can be an active sensor employing capacitive, resistive, inductive, or other methods, or it can be a passive surface on which touch sensing is accomplished by optical, acoustic, or other similar methods. Device 310 can also be a liquid crystal display (LCD), organic light emitting diode (OLED) display, electroluminescent display, or any other type of small display suitable for mounting in a portable computer or mobile device. Device 310 may be color or monochrome, and may include a backlight capability to enhance readability in various lighting conditions.

In the present invention, device 310 displays a suitability document or questionnaire 314 for completion by a user such as an insurance consumer or another entity on behalf of the consumer. The information provided by the questionnaire 314 is then transmitted to an agent device screen 320. Agent device screen 320 displays an electronic scoring table 324 for evaluating consumer questionnaire information to determine suitability of the consumer for one or more of the insurance/financial products such as an income annuity or fixed annuity. Once suitability is determined via agent device 320, the consumer may be provided access to an insurance or financial services entity screen 330. Screen 330 displays information 334 on one or more insurance/financial services product(s) that have been determined to be suitable for the consumer based on their scored questionnaire. In one embodiment, the consumer may then begin the purchase or registration process to select one or more of the products based on the suitability determination either by interacting with the agent or alternatively directly, such as through screen 330. In other embodiments, the various screens illustrated in FIG. 3 may be provided on a single device or apparatus such as an agent operated device or apparatus. The user or consumer may interact either locally or remotely with the agent operated device.

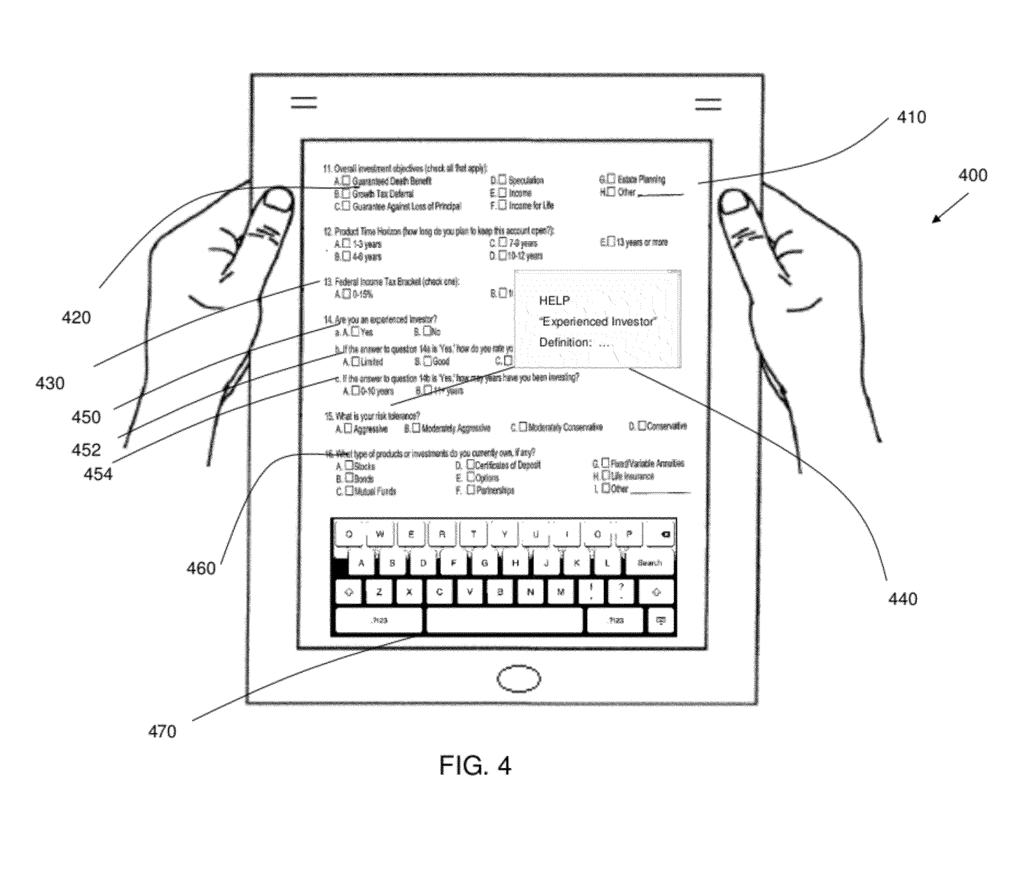

Turning now to FIG. 4, an exemplary user device 400 is illustrated displaying an electronic suitability questionnaire document 410, also referred to herein as form 410. Suitability document 410 may be generated by the suitability document generation module 114 of suitability management system 110. Electronic suitability document 410 is configured to receive certain information and input on behalf of the user through a series of dynamically rendered questions provided on user device 400. Such information and input provided by the user in response to the questions is then scored to determine the validity of a product recommendation for the user or alternatively the user's suitability for one or more insurance and/or financial service products. The suitability questionnaire document 410 is configured to evaluate the user's investment/financial acumen or knowledge, such as how familiar the user is with insurance products and general investments; the user's tolerance for risk such as on a conservative, moderately conservative, moderately aggressive and aggressive scale or based on selection of a risk profile such as one of conservative, moderately conservative, moderately aggressive and aggressive; and the user's solvency, such as their income, net worth, source of income for the product, etc. Other factors may also be evaluated such as their cognitive ability. A user's cognitive ability may be evaluated based on third party data, monitoring the user's interaction with the suitability questionnaire document 410 such as the time and length taken for completion of the document and also using other facilities and devices as may be available via a variety of sensors and detection devices. The system, such as suitability management system 110 constantly monitors the displayed information to the user as well as the user responses and actions on the device 400. In operation, the user moves from one form field to another form field such as field 420 to 430 to compete each selected question displayed in each form field. An electronic pop-up type display 440 is available for one or more of the fields to provide additional assistance or clarification with respect to one or more of the form fields if requested by the user through a specified action, such as by double clicking or tapping the relevant question. Form 410 may include additional fields such as an agent certification field to allow an agent to certify the accuracy of the form and other fields such as a field indicating that a client has refused to complete the form.

Form 410 may be electronically configured to allow and/or prevent certain actions such as skipping certain fields or questions or from changing certain answers once input into form 410. Form 410 may also be configured to intelligently parse answers to certain questions based on answers provided to previously completed questions and then take additional action via form 410 on user device 400 based on a number of business rules coded into the present system. By way of example, form 410 may be configured to determine and present, dependent on a received answer, a next question. For example, with respect to the question, “14(a). Are you an experienced investor” in field 450, if a user selects the answer “no” then questions 14(b) and 14(c) in fields 452 and 454 would subsequently disappear from document 410 as displayed. By way of further example, if a user were to not complete any of the selections in question “16. What types of products or investments do you currently own, if any”, field 460, but the user had previously indicated they had extensive investment experience in question 14(b), field 452, the form 410 would prompt the user, such as via a pop up type display to question if the answer to question 16, field 460, was correct. The user would then be given the opportunity to change the answer to their question in form 410. Such changes in the answers may be recorded and stored, such as in a database 224 described in FIG. 2 and such information may b used in the suitability evaluation. For example, if the user consistently changes answers to certain questions and/or enters in conflicting answers to certain questions, the suitability management system 110 of FIG. 1a or 1b may flag the questionnaire as requiring additional verification or validation. Such behavior and other similar behavior of the user may also result in a weighting or other factor applied to the scoring of the suitability questionnaire as discussed in more detail later herein.

Referring still to FIG. 4, if the user moves to another field without making a selection from the previous question field, the system may prevent further completion of the form 410 without completion of the previous question field. If the user manually inputs a new value in a requested form field, the invention detects this new value, and may dynamically select, order and display one or more follow on questions based on the context of the new value provided. For example, if a user responds to the question “What is your risk tolerance?” with the answer “Aggressive”, the selections to the follow on question “What types of products or investments do you currently own, if any?” would be formatted and displayed in a manner reflecting the “Aggressive” answer such as by providing the choices of answers in the order of “Options, Stocks, Variable Annuities, etc. . . . ” If the user had responded as “Conservative”, the choices to the “What types of products or investments do you currently own, if any?” question would be re-ordered and presented as: “Certificates of Deposit, Bonds, Life Insurance, etc. . . . ”

In the present invention, device 400 may be a touch sensitive display that is responsive to a finger, a stylus, etc. for manipulation and completion of form 410. Certain operating circuitry may control or operate device 400 to show different respective images, such as, for example, suitability question, text instructions or information, an image of a keypad 470, icons or functions of a graphical user interface (GUI), lists of information, etc., as is known. Keypad 470 may also be a physical keypad having keys or buttons that are positioned on or in the housing or keypad 470 may be formed as an image on device 400.

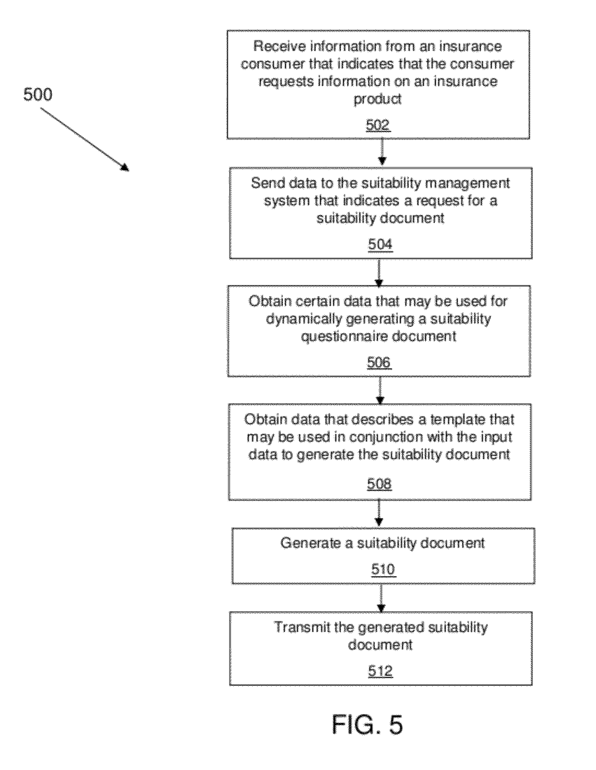

FIG. 5 shows an example method 500 for communicating a suitability questionnaire document to an insurance consumer using the example architecture 100 of FIG. 1. The method 500 of FIG. 5 may begin with an employee or agent at the insurance company receiving information from an insurance consumer that indicates that the consumer requests information on an insurance product (step 502). This information may be communicated to the insurance company in any number of ways, such as via telephone conversation, in-person, fax, email, mail, or any other appropriate mechanism.

After receiving this information, the insurance company or agent acting on the insurance company's behalf may have the consumer complete a product application as well as a suitability questionnaire. Data may be sent to the suitability management system 110 that indicates a request for a suitability document (step 504). This may include the agent client module 142 transmitting one or more messages and/or other information to the suitability document generation module 114 in the suitability management system via the interface module 112. The request may include an identifier of the insurance consumer, information that indicates the reason that the consumer is requesting the product and/or other preliminary information. It is contemplated that a consumer may also directly provide such preliminary information and request a suitability document such as via web browser module 134 via web system 120 which interfaces with suitability management system 110.

After receiving the request for the suitability document, the suitability document generation module 114 may obtain certain data that may be used for dynamically generating a suitability questionnaire document (step 506). The input data may include data that describes attributes of the consumer, data related to one or products that the consumer expressed an interest in and/or other information. The suitability document generation module 114 may read in data from and/or perform one or more searches in or queries to the suitability management database 116 and the product management database 162 in helping generate the suitability questionnaire document. The searches or queries may be based on the identifier of the insurance consumer, and/or other information related to the insurance consumer. The consumer data may include one or more of: address information for the consumer (including the state in which the consumer resides); the consumer's name; a phone number for the consumer; etc.

The suitability document generation module 114 may then obtain data that describes a template that may be used in conjunction with the input data to generate the suitability document (step 508). This may include reading data from the suitability management database 116 that contains template definitions and constructs. Alternatively or additionally, this may include performing a lookup and/or issuing one or more queries to the suitability management database 116 to obtain template related data. As one example, the suitability document generation module 114 may perform a lookup in the suitability management database 116 based on the state in which the insurance consumer resides, to obtain a template that corresponds to NAIC model regulations and/or the insurance consumer's state. Generally, it is contemplated that state Department of Insurance requirements and guidelines for suitability evaluations may vary for certain states and database 116 may include the various requirements and guidelines specific to each state Department of Insurance and/or any other regulations which may apply.

A template document or construct used by the suitability document generation module 114 may include, among other information, a set of suitability questions to be included in a finalized suitability document that is generated based on the template. The template document may include information that describes whether particular questions or groups of questions should be included in the finalized suitability document. The suitability document generation module 114 then determines based on a number of business rules the questions or groups of questions should be included in the finalized suitability document based on parameters such as attributes of the insurance consumer, attributes of the insurance product(s) the insurance consumer has requested, the state or other jurisdiction whose legal requirements are applicable to the suitability document, and/or other factors. For example, the business rules may indicate that a template may include a first group of questions that apply to circumstances only where an insurance consumer is interested in obtaining an index annuity product, and a second group of questions that apply only to circumstances where an insurance consumer is interested in a single premium annuity type of product. The business rules may also indicate the order and form of certain questions, for example, a first group of questions in a first order should be included when the insurance consumer is from a state such as Texas, and a second group of questions in a second order should be included when the insurance consumer is from a state such as New York. The business rules may also provide that in certain circumstances, such as certain information about the consumer and/or their certain geographic location, the finalized suitability suitability document should not include certain questions.

Templates used by the suitability document generation module 114 to generate suitability documents may be defined according to a number of different formats. For example, a template may be defined according to an Extensible Stylesheet Language Transformations (XSLT) format, a format defined according to a template technology such as MVFLEX Expression Language (MVEL), StringTemplate, Freemarker, Velocity, or other template technology, a specific-purpose template format, and/or any other appropriate format.

After obtaining data that describes a template that may be used to generate the suitability document, the suitability document generation module 114 may generate a suitability document (step 510). Generating the suitability document may include conforming to the relevant business rules, the obtained consumer data, the obtained product(s) data, and/or the information included in the request, and determining the questions to include or not include in the suitability document. Further, generating the suitability document may include pre-filling portions of the suitability document with information related to the insurance consumer on whose behalf the suitability was requested and/or related to the employer of the insurance consumer. The generated suitability document may be formatted according to a format such as a Microsoft Word format, Adobe Portable Document Format (PDF), Open Document Format for Office Applications (ODF) format, Hypertext Markup Language (HTML) format and/or any other appropriate format.

After generating the suitability document, the suitability document generation module 114 may transmit the generated suitability document to the agent device 140 via the interface module 112 (step 512). Upon receiving the generated suitability document, the user of the agent device 140 may complete the suitability document on behalf of the consumer with the input of the consumer or the user may provide the generated suitability document to the insurance consumer on client device 132. To provide the suitability document to the insurance consumer, the user of the agent device 140 may transmit the suitability document via suitability management system 110 and web system 120.

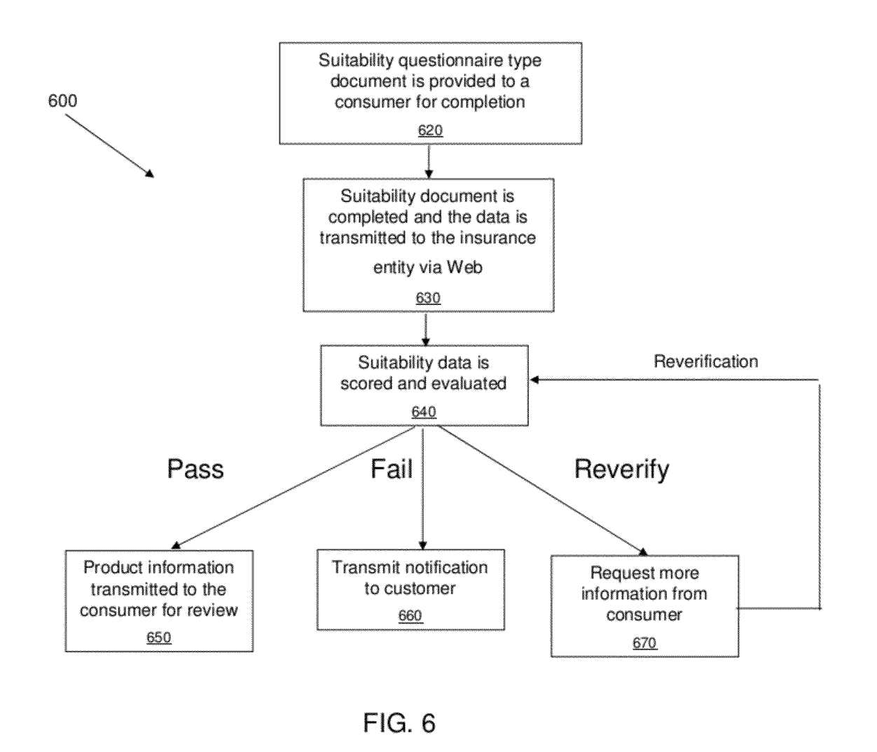

FIG. 6 shows another method 600 of the present invention. Here the consumer may access the suitability document directly via web system 120 instead of interfacing with an agent via agent device 140. According to this approach, the suitability web application module 112 may determine the contents of web pages that it transmits to the insurance consumer to obtain suitability information by performing similar processing as that described above as performed by the suitability document generation module 114 in FIG. 1b.

The suitability web application module 122 may then communicate with the insurance consumer via the web browser module 134 to obtain the suitability information. (step 620) This may include the suitability web application module 122 transmitting one or more web pages to the web browser module 134. The web pages may be generated based on information received by the suitability web application. The web pages may include forms and/or data entry fields that solicit suitability information from the insurance consumer. The solicited information may include any combination of the information solicited in the example suitability document 410 of FIG. 4 and/or any other appropriate suitability information. The insurance consumer may enter the suitability information into the suitability questionnaire and/or data entry fields, and the web browser module 134 may be used for transmitting the suitability information to the suitability web application module 122 for receipt by web system 120. (step 630).

Upon receiving the suitability information, the suitability web application module 122 may communicate with suitability management system 110 to score the suitability information and validate the recommended product offering (step 640). Alternatively, suitability management system 110 may be used to pre-screen which product(s), such as those product stored in database 162 of product management system 160 are suitable for the insurance consumer. This may include the suitability web application module 122 transmitting the suitability information received to suitability management system 110 for scoring and analysis. In instances, where the consumer has also completed one or more product application(s), the product application information is also transmitted to suitability management system 110. Based on the suitability information transmitted to the suitability management system 110, the suitability management system 110 may determine that the consumer is suitable for one or more insurance product(s), the consumer is not suitable for one or more insurance product(s) and/or the suitability information needs to be reverified.

The suitability web application module 122 may then transmit one or more web pages to the web browser module 134 that indicate the determination made by the suitability management system 110. If the determination concludes that it might be suitable to recommend one or more insurance products such as a Single Premium Immediate Annuity (SPIA) or an Index Annuity, information regarding these products is transmitted to the consumer, (step 650). Such information may be general information about the product, a product application and/or information related to consummating the actual purchase of the insurance product if the consumer has already completed a product application. If the determination concludes that it might not be suitable to recommend the particular insurance product for the consumer, a notification may be provided to the consumer such as information pertaining to certain alternative products such as Certificate of Deposits (CD) or other products for which a suitability analysis is not necessary or might result in a more appropriate recommendation, (step 660). The web browser module 134 may then display the one or more web pages to the user of the consumer client device 132. In an instance where the insurance company requires more information in order to determine whether to determine suitability (step 670) the web pages may also indicate what additional information is required by the insurance company, and how the insurance consumer may go about providing the additional information to the insurance company. In one embodiment, the consumer may employ client device 132 to transmit electronic documents via web system 120 to suitability management system. Such electronic documents may relate to financial/insurance product accounts, bank accounts and other information that may be used by suitability management system in conducting the suitability analysis.

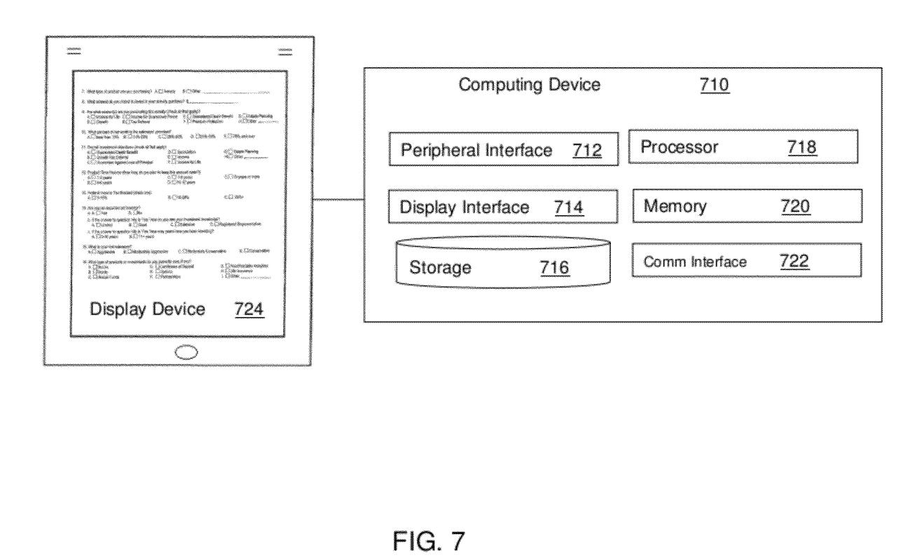

FIG. 7 shows an example computing device 710 that may be used to implement features describe above with reference to FIGS. 1-5. The computing device 710 may include a peripheral device interface 712, display device interface 714, and storage device 716, a processor 718, memory device 720, and a communication interface 722. FIG. 7 also shows a display device 724, which may be coupled to or included within the computing device 710.

The peripheral device interface 712 may be an interface configured to communicate with one or more peripheral devices. The peripheral device interface 712 may operate using a technology such as Universal Serial Bus (USB), PS/2, Bluetooth, infrared, serial port, parallel port, and/or other appropriate technology. The peripheral device interface 712 may, for example, receive input data from an input device such as a keyboard, a mouse, a trackball, a touch screen, a touch pad, a stylus pad, and/or other device. Alternatively or additionally, the peripheral device interface 712 may communicate output data to a printer that is attached to the computing device 710 via the peripheral device interface 712.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 710.

The memory device 720 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

An instance of the computing device 710 of FIG. 7 may be configured to perform any feature or any combination of features described above as performed by the consumer client device 132. In such an instance, the memory device 720 and/or the storage device 716 may store instructions which, when executed by the processor 718, cause the processor 718 to perform any feature or any combination of features described above as performed by the web browser module 134. Alternatively or additionally, in such an instance, each or any of the features described above as performed by the web browser module 134 may be performed by the processor 718 in conjunction with peripheral device interface 712, display device interface 714, and/or storage device 716, memory device 720, and communication interface 722.

Alternatively or additionally, an instance of the computing device 710 may be configured to perform any feature or any combination of features described above as performed by the suitability management system 110. In such an instance, the memory device 720 and/or the storage device 716 may store instructions which, when executed by the processor 718, cause the processor 718 to perform any feature or any combination of features described above as performed by the interface module 112 and/or the suitability document generation module 114. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the agent device 140. In such an instance, the memory device 720 and/or the storage device 716 may store instructions which, when executed by the processor 718, cause the processor 718 to perform any feature or any combination of features described above as performed by the agent client module 142. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the web site system 120. In such an instance, the memory device 720 and/or the storage device 716 may store instructions which, when executed by the processor 718, cause the processor 718 to perform any feature or any combination of features described above as performed by the suitability web application module 122 and/or the HTTP server module 124. In such an instance, the processor 718 may perform the feature or combination of features in conjunction with the memory device 720, communication interface 722, peripheral device interface 712, display device interface 714, and/or storage device 716.

Although FIG. 7 shows that the computing device 710 includes a single processor 718, single memory device 720, single communication interface 722, single peripheral device interface 712, single display device interface 714, and single storage device 716, the computing device may include multiples of each or any combination of these components 718, 720, 722, 712, 714, 716, and may be configured to perform analogous functionality to that described above.

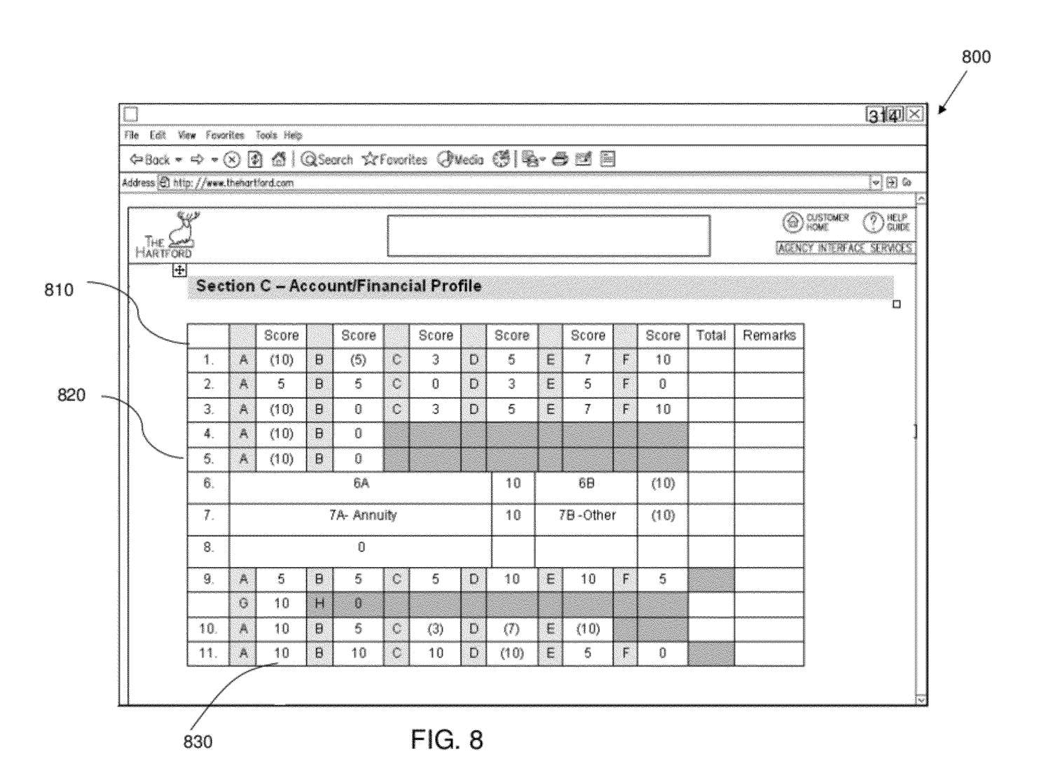

FIG. 8 illustrates an exemplary suitability scoring screen of the present invention as may be utilized by an agent device such as agent device 140 shown in FIG. 1a. Screen 800 includes a scoring matrix 810 which may be stored in suitability management system 110 within database 116 for use in scoring consumer suitability questionnaires as rendered by suitability document generation module 114. Scoring matrix 810 may also be coded into suitability management system 110 as part of the business rules for generating and evaluating suitability documents. Scoring matrix 810 may thus provide weighted scores for each of the questions in the suitability questionnaire. Screen 800 includes a series of rows 820 which correspond to questions on the suitability questionnaire document and series of columns 830 which provide a score corresponding to each question. For example, in screen 800, question 5(A) is associated with a score of “10” and question 10(C) is associated with a score of “3”. It is contemplated that any number of various scoring scales and factors may be used to provide a relative scoring of questions and answers in the present invention. Additional scoring factors within scoring matrix 810 may relate to how much time the consumer took to fill out the questionnaire form, whether the consumer changes any answers to specific questions in the form and the various background information about the consumer that may be available via third party sources such as credit history, social network activity, etc accessed via third party data source 150 shown in FIGS. 1 and 1b. Such third party sources may be used to evaluate a consumer's acumen, tolerance and solvency. For example, if a consumer is an active on a number of financial and insurance related websites, then the consumer may be deemed to have some experience as an investor.

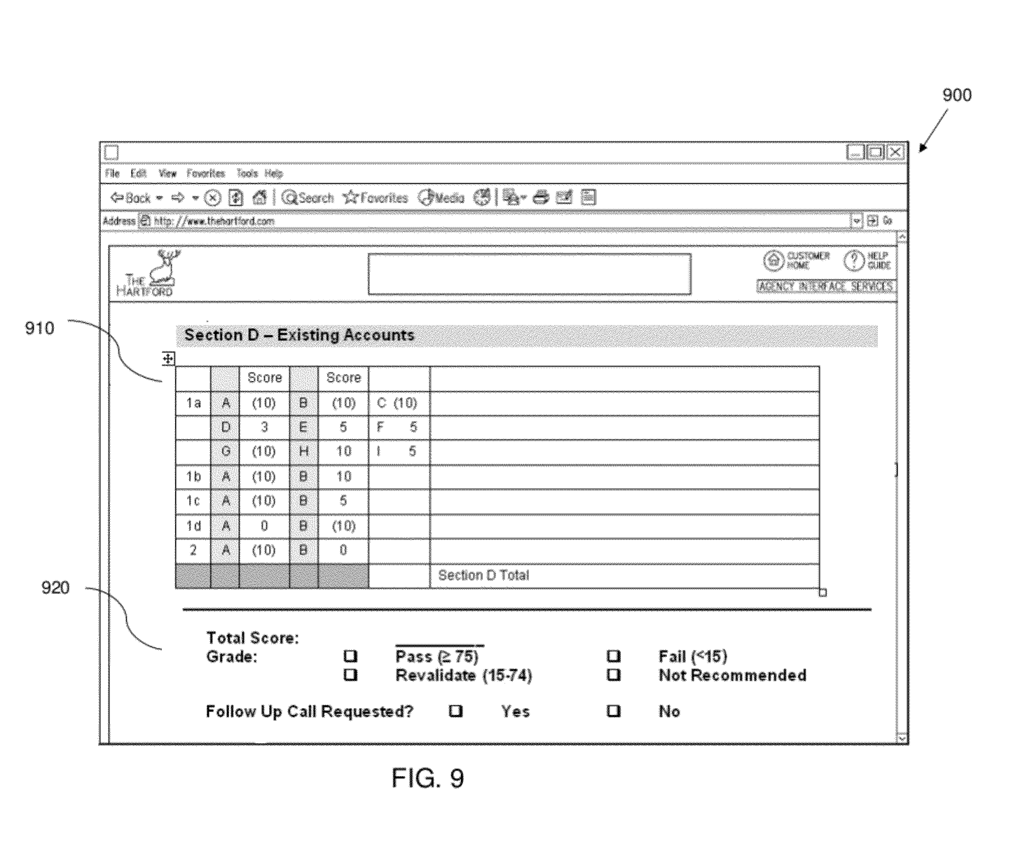

FIG. 9 illustrates another exemplary suitability scoring screen 900 of the present invention as may be utilized by an agent device such as agent device 140 shown in FIG. 1a. Screen 900 includes a scoring matrix 910 which may be stored in suitability management system 110 within database 116 for use in scoring consumer suitability questionnaires as rendered by suitability document generation module 114. Screen 900 also includes a summary section 920 for displaying and recording results of the questionnaire scoring. In scoring the documents, the aggregate scores for all the questionnaire questions are compiled according to scoring matrix 910 and the totals are tallied and correlated with generally a “pass”, “fail” and “revalidate” as provided in summary section 920, as also discussed with reference to FIG. 6.

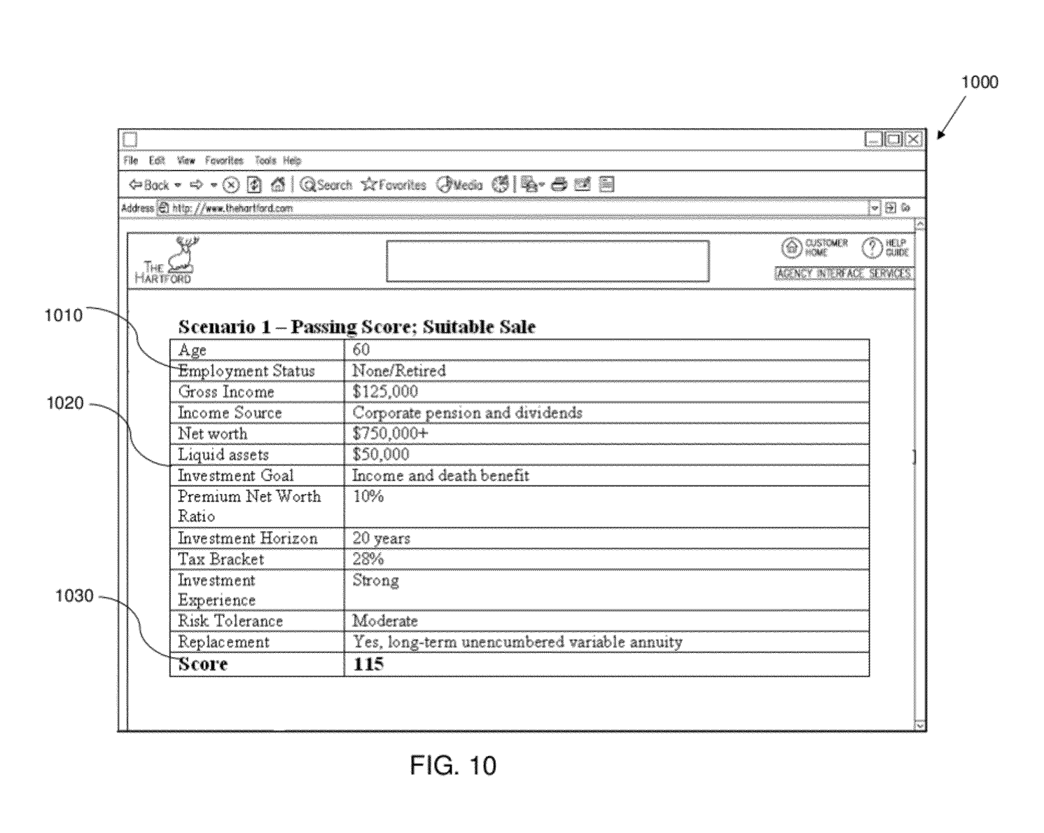

FIG. 10 illustrates an exemplary suitability scoring results screen 1000 of the present invention as may be utilized by an agent device such as agent device 140 shown in FIG. 1a. Screen 1000 includes a passing score summary 1010 for a hypothetical consumer. Summary 1010 includes related information 1020 for the consumer and a score section 1030 based on results of the questionnaire scoring. This consumer has received a score of “115” or a “pass” as determined by suitability management system 110 of FIG. 1a or FIG. 1b. This consumer may be recommended to consider one or more product options such as an index annuity, as may be stored in database 162 of product management system 160 of FIG. 1a or FIG. 1b. The score displayed in FIG. 10 may comprise any number of variations and correlates to the relative ranges of passing, failing and re-verifying as established by the insurance entity and/or prescribed by the governing regulatory authority.

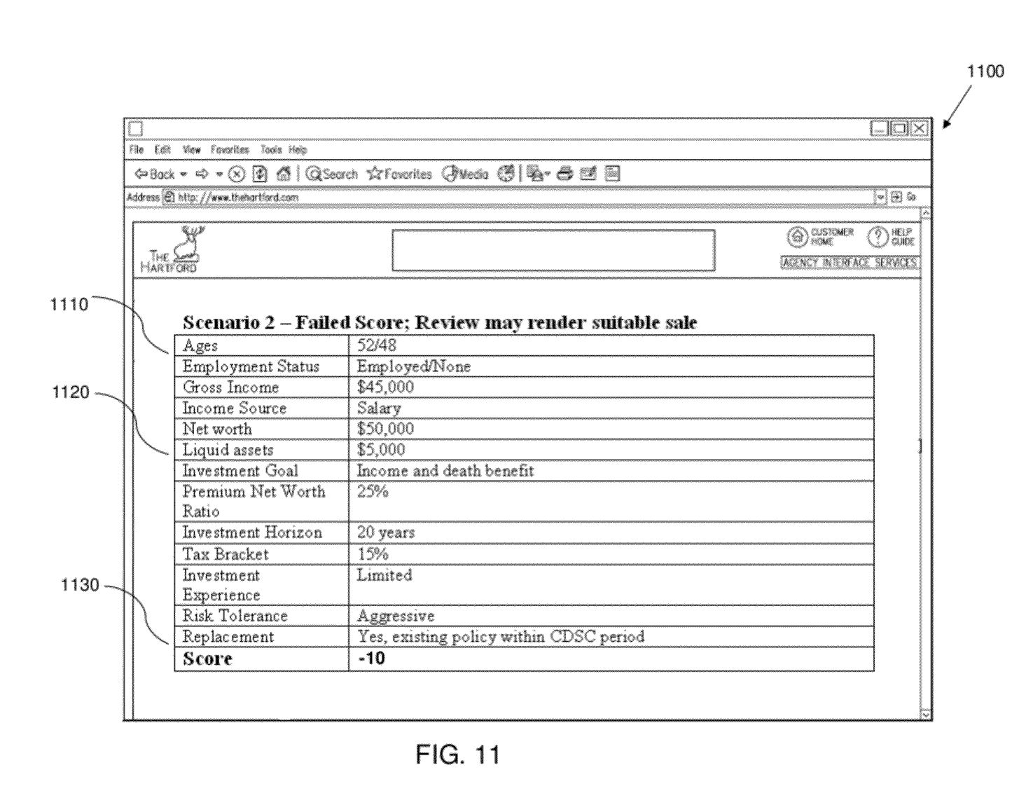

FIG. 11 illustrates another exemplary suitability scoring results screen 1100 of the present invention as may be utilized by an agent device such as agent device 140 shown in FIG. 1a. Screen 1100 includes a failed score summary 1110 for a hypothetical consumer. Summary 1110 includes related information 1120 for the consumer and a score section 1130 based on results of the questionnaire scoring. This consumer has received a score of “10” or a “fail” as determined by suitability management system 110 of FIG. 1a or FIG. 1b. This consumer will not be provided one or more product options, such as a deferred annuity, as may be stored in database 162 of product management system 160 of FIG. 1a or FIG. 1b but may be provided one or more alternative product options such as a certificate of deposit or other similar product for consideration.

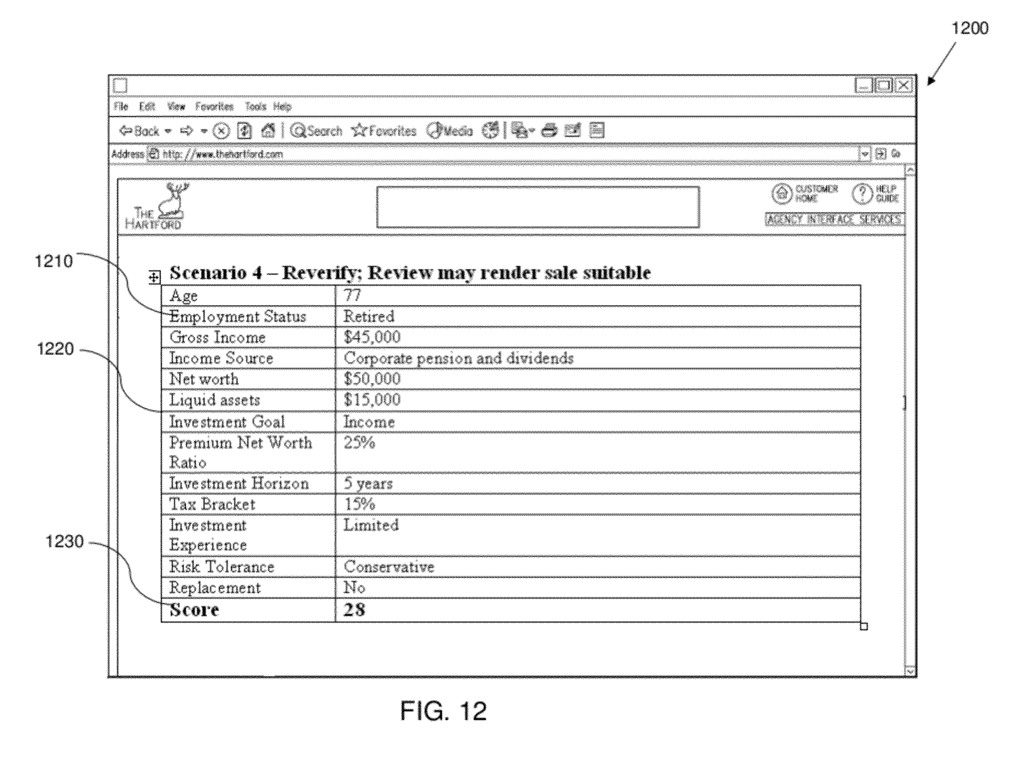

FIG. 12 illustrates another exemplary suitability scoring results screen 1200 of the present invention as may be utilized by an agent device such as agent device 140 shown in FIG. 1a. Screen 1200 includes a reverify score summary 1210 for a hypothetical consumer. Summary 1210 includes related information 1220 for the consumer and a score section 1230 based on results of the questionnaire scoring. This consumer has received a score of “28” or a “reverify” as determined by suitability management system 110 of FIG. 1a or FIG. 1b. This consumer may be provided one or more product options as determined by further verification of their suitability. Reverification may include soliciting the consumer for additional evidence or documentation related to their suitability questionnaire which may be provided by the consumer via their device 400 of FIG. 4. Verification may include the consumer providing additional documentation regarding their assets, investments, etc. for consideration by the insurance entity and/or the agent acting on behalf of the insurance entity. The additional documentation may then be reviewed by suitability management system 110 and then re-scored to see if the additional documentation results in a different score for the consumer. It is contemplated that suitability management system 110 may have one or more business rules for handling such additional documentation such as rules for establishing proof and substantive thresholds for the additional documentation and any adjustments to the scoring matrices as necessary. If re-verification is successful, the recommendation to the consumer may be validated and the consumer may be provided certain product options such as an income annuity which to purchase.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device, including other type of non-transitory computer-readable medium, for electronic data storage.

Although the methods and features described above with reference to FIGS. 1a-12 are described above as performed using the example architecture 100 of FIG. 1a and the example system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described above with reference to FIGS. 1a-12 may be used alone without the other features and elements or in various combinations with or without other features and elements. Sub-elements of the methods and features described above with reference to FIGS. 1a-12 may be performed in any arbitrary order (including concurrently), in any combination or sub-combination.

What is claimed is:

1. A system for managing and scoring suitability data for selection of one or more insurance products for one or more consumers, comprising:
a data storage device storing data associated with an insurance product suitability database;
a computer processor for executing program instructions and for retrieving said data associated with the insurance product suitability database from the data storage device; and
a memory, coupled to the computer processor, storing program instructions for execution by the computer processor to:
receive, from a remote consumer entity, a request for information on one or more of the insurance products stored in the insurance product suitability database, the request also including information specific to the remote consumer entity;
render a dynamic suitability questionnaire based on the received request, the dynamic suitability questionnaire customized based on the information specific to the remote consumer entity,
receive, from the remote consumer entity, data provided in response to the rendered suitability questionnaire;
store the received data in the insurance product suitability database;
analyze the stored data based on a set of suitability rules to determine a suitability score based on at least the consumer entity's acumen, tolerance and solvency; and
transmit, based on the analysis, data related to selected insurance products for presentation to the consumer.

2. The system of claim 1, wherein the information specific to the remote consumer entity relates to the consumer's geographic location.

3. The system of claim 1, wherein the dynamic suitability questionnaire comprises a questionnaire template and a series of dynamically selected suitability questions.

4. The system of claim 3, wherein the suitability rules define a weighted score for each of the suitability questions.

5. The system of claim 3, wherein the suitability rules define a set of suitability score ranges, where at least one range correspond to either pass, fail or reverify.

6. The system of claim 5, wherein the instructions further cause the processor to transmit a request for additional information to the consumer responsive to the suitability score being determined to be in the reverify range.

7. The system of claim 1, wherein analyzing the stored data based on a set of suitability rules comprises accessing third party information sources related to social network activity.

8. The system of claim 1, wherein acumen is based on the type of products the consumer currently owns, tolerance is based on the consumer's risk profile and solvency is based on the consumer's net worth.

9. The system of claim 7, wherein the dynamic suitability questionnaire prevents changing answers to one or more questions.

10. The system of claim 7, wherein the answer to one question determines which question is next presented to the consumer in the dynamic suitability questionnaire.

11. A system for generating and scoring suitability data for one or more insurance products, the system comprising:
a communication interface configured to receive data from a computing device that indicates a request for a suitability document,
wherein the request for the suitability questionnaire document relates to a request by an insurance consumer for the one or more insurance products; and
at least one processor configured to:
selectively compile suitability questions, each question associated with a suitability score, aggregated scores forming certain scoring ranges;
receive consumer answers to each of the suitability questions via the communications interface, the answers being aggregated to form an overall suitability score; and
correlating the overall suitability score to one or more of the scoring ranges to form a suitability evaluation;
wherein the communication interface is further configured to transmit data related to one or more of the insurance products based on the correlation of the overall suitability score and the one or more scoring ranges to the computing device.

12. The system of claim 11, wherein a product application is submitted concurrently with the consumer answers to the suitability questions.

13. The system of claim 12, wherein one or more of the suitability questions are pre-filled based on the product application.

14. The system of claim 11, wherein the suitability questionnaire document is used to evaluate the consumer on an acumen, tolerance and solvency basis.

15. The system of claim 11, wherein the scoring ranges correspond to either a pass, fail or re-verify status.

16. The system of claim 15, further comprising: transmitting one or more alternative products to the consumer responsive to the scoring range corresponding to a fail status.

17. The system of claim 15, further comprising: transmitting one or more product options to the consumer responsive to the scoring range corresponding to a pass status.

18. The system of claim 15, further comprising: transmitting a request for additional documentary evidence from a consumer responsive to the scoring range corresponding to a re-verify status.

19. A computer-implemented method for generating and scoring a suitability questionnaire for evaluating suitability for a non-security product, the method comprising:
receiving, via a communication interface, a message from a computing device that indicates a request for a suitability questionnaire;
dynamically compiling, via at least one processor, a suitability questionnaire for transmission to a user via the communications interface, wherein the suitability questionnaire comprises a plurality of questions for completion by the user, each question having an associated suitability score assigned to each question;
receiving, via the communications interface, information responsive to the suitability questionnaire;
storing, in at least one storage device, the information responsive to the suitability questionnaire;
scoring, by the at least one processor, the information responsive to the suitability questionnaire based at least in part on the suitability score assigned to each question in the suitability questionnaire; and
transmitting, via the communication interface, information related to the purchase of the fixed annuity product, to the computing device.

20. The computer-implemented method of claim 19, wherein the non-security product is one of a single premium immediate annuity and a fixed deferred annuity.

21. The computer-implemented method of claim 19, further comprising requesting additional information from the user and re-scoring the additional information provided by the user.

22. The computer-implemented method of claim 19, wherein scoring, by the at least one processor, includes determining whether the information responsive to the suitability questionnaire has been changed by the user during completion of the suitability questionnaire by the user.

23. The computer-implemented method of claim 19, wherein scoring, by the at least one processor, includes accessing third party data sources related to social network activity of the user.

24. The computer-implemented method of claim 23, wherein the social network activity of the user is used to assign certain suitability scores to questions related to the user's acumen.
